(19) United States
(12) Patent Application Publication
(10) Pub. No.: US 2020/0259944 A1
(43) Pub. Date: Aug. 13, 2020

(54) PERSONAL SAFETY SYSTEMS AND METHODS FOR ALERTING IN AN EMERGENCY SITUATION

(71) Applicant: Gad BENETT, Rehovot (IL)

(72) Inventors: Matania HOGGEG, Misgav Dov (IL); Gad BENETT, Rehovot (IL)

(21) Appl. No.: 16/859,206

(22) Filed: Apr. 27, 2020

Related U.S. Application Data
(63) Continuation-in-part of application No. 15/763,922, filed on Mar. 28, 2018.
(60) Provisional application No. 62/237,689, filed on Oct. 6, 2015.

(51) Int. Cl. H04M 1/725; G06Q 50/26; H04B 1/3827; H04W 4/029; H04W 4/90

(52) U.S. Cl. CPC H04M 1/72541; G06Q 50/265; H04B 1/385; H04M 2242/04; H04W 4/029; H04W 4/90; H04B 2001/3861; H04M 1/7253

(57) ABSTRACT

Personal safety systems and methods for alerting in an emergency situation, using a personal bracelet that can communicate with a mobile phone application. When the bracelet is worn at a palm-position, an annex-portion of the bracelet is worn across the wrist, going across the palm and between the thumb and the index finger, exposing actionable buttons. The actionable buttons can be operated by the fingers of the same hand where the bracelet is worn. Pressing a predetermined sequence generates an emergency message to a security service along with the user's location and sound and images recorded by the phone.

### CROSS-REFERENCE TO RELATED APPLICATIONS

This application is a continuation-in-part of U.S. patent application Ser. No. 15/763,922 filed on 28 Mar. , 2018, claiming priority of PCT/IL2016/051078 filed Oct. 5, 2016, which claims the benefit of priority of U.S. Provisional Patent Application No. 62/237/689, filed 6 Oct. 2015. The content of these applications are hereby incorporated by reference in their entirety.

### TECHNICAL FIELD

The present invention relates to systems and methods for personal safety in general, and in particular to a mobile phone application and a personal bracelet for generating alerts in an emergency situation.

### BACKGROUND ART

The mobile phone has become an important function in the everyday life of many people, and can many more task than simply talking with another telephone. Some of the usages of a mobile phone include: listening to music, taking pictures and videos, navigation etc. The mobile phone can also be used as a remote controller to operate other devices such as a television, projector, air-conditioning units and many other devices.

Most of the time, a user operates the mobile phone directly by holding the phone in one hand and operating the phone either with the same hand that's holding the phone (typically by the thumb of the holding hand), or by the other hand (one hand holding the phone, the other hand operating the phone).

In some contexts, a user may wish to use a function of the mobile phone quickly without accessing the mobile phone directly. For example, when jogging while listening to music if the user wishes to change songs (say next song on the playlist), normally the user has to stop jogging in order to access the phone and change songs. Another example is when a user wishes to call for help, but cannot or does not want to use his phone directly, such as when walking alone on the street and seeing a suspicious person approaching and preferring to watch that person and the surroundings instead of taking out and manipulating a mobile phone.

Different wearable products exist or are in development today to enable the user to operate some of the mobile phone functions. Some of these products include: smart watches, rings and dedicated buttons.

The smart watch is worn on the hand like a regular watch and can connect to a smart phone wirelessly. The smart watch is operated via a touchscreen and/or dedicated buttons which activate and operate mobile applications and functions. Using the smart watch requires the user to use the other hand and have eye contact with the watch.

Rings are another category of wearable communicating devices. Typically, the user needs to press a button on the ring and perform a gesture that is understood by an application on the mobile phone.

There are some dedicated buttons, like one that is attached to the mobile phone's headphone entry, and pressing this button activates a preprogrammed function at the mobile device.

### SUMMARY OF INVENTION

It is an object of the present invention to disclose a bracelet that communicates with a coupled electronic device.

It is another object of the present invention to disclose a bracelet that communicates with a mobile phone.

It is a further object of the present invention to disclose a bracelet that can be operated by a finger.

It is yet another object of the present invention to disclose a bracelet that can be operated by a finger of the same hand where the bracelet is worn.

It is yet a further object of the present invention to disclose a bracelet that can be operated by a finger of the same hand where the bracelet is worn without eye-contact between the user and the button.

The present invention relates to a personal safety system for alerting in an emergency situation, the system comprising:
A. a personal bracelet, comprising
   (i) a base-portion adapted to be worn on the wrist;
   (ii)an annex-portion connected to the base-portion and adapted to be retracted and worn in a palm position across the palm between the thumb and the index finger, the annex-portion comprising one or more actionable buttons;
   (iii) a communication unit connected to said one or more actionable buttons comprising a power source and a wireless transmission module,
   wherein when, in an emergency situation, one or more buttons of said actionable buttons are manipulated by the user, a personal safety instruction associated with said manipulation is transmitted by the wireless transmission unit to the coupled mobile phone; and
B. a mobile phone application running on said couple mobile phone, adapted to receive instructions from said wireless transmission unit, and perform the following actions in response:
   (i) send a personal emergency message to a predefined security service, the message comprising at least the identity of the mobile phone user and mobile phone location information;
   (ii)activate at least one of the mobile phone's microphone and camera to capture sound and/or video;
   (iii) continuously transmit to a database coupled to said security service the captured sound and/or video; and
   (iv) transmit to said database continuously or at predetermined intervals, mobile phone location information.

In some embodiments, the security service is a law enforcement agency or a commercial service.

In some embodiments, the security service is a commercial security agency and said commercial security service contacts a law enforcement agency to assist the mobile phone user.

In some embodiments, the commercial security service transmits to said law enforcement agency or makes available to said law enforcement agency, any sound and/or video received from the mobile phone.

In some embodiments, the database belongs to the user of the mobile phone or to a third party, and access to said database is given to said security service.

In some embodiments, the sound and/or still images and/or video are processed to identify potential danger to the mobile phone user.

In some embodiments, an actionable button can be manipulated by touching the button, touching the button twice within a predetermined time, pressing the button, pressing the button twice within a predetermined time, pressing the button for predefined periods of time, moving the button, twisting the button, sliding the button or any combination thereof.

In some embodiments, more than one actionable buttons are manipulated simultaneously.

In some embodiments, the position of one or more actionable buttons on the annex-portion is configurable, such that said one or more actionable buttons can be moved to a different location along the annex-portion in order to better fit user preferences and physiology.

In some embodiments, the communicating bracelet is a shirt with an opening at the end of a sleeve.

In some embodiments, the emergency message places the system in a watch mode, and the system awaits for a predetermined amount of time for an instruction to maintain or cancel the watch mode before acting on the emergency situation.

### BRIEF DESCRIPTION OF DRAWINGS

FIGS. 1A-1B show an embodiment of the communicating bracelet in the wrist position. FIG. 1A showing the bracelet on its own, and FIG. 1B showing the bracelet worn on a hand, in the wrist position.

FIG. 2 shows an embodiment of the communicating bracelet in palm position where the annex-portion of the bracelet is worn across the wrist. The user can press on an action-button with the same hand where the bracelet is worn.

FIG. 3 shows an embodiment the communicating bracelet in the palm position where the communication unit's position on the annex-portion can be adjusted.

FIG. 4 shows an embodiment the communicating bracelet where the annex-portion can be detached at one end.

FIG. 5 shows the bracelet of FIG. 4 where the user detaches one end of the annex-portion in order to wrap it around the wrist and then attach it again to the base-portion.

FIG. 6 is a block diagram showing the mobile phone connecting to a security service and uploading sound and/or video.

FIG. 7 is a flowchart of a process of sending an emergency message according to one embodiment of the present invention.

FIG. 8 shows an embodiment the communicating bracelet where the base-portion is a shirt.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a personal safety system that comprises a personal, wearable, communicating bracelet that communicates with a mobile phone application. The bracelet has one or more actionable buttons. When the bracelet is worn at a palm-position, an annex-portion of the bracelet is worn across the wrist, going across the palm and between the thumb and the index finger. The actionable buttons can be operated by the fingers of the same hand where the bracelet is worn. The user can operate the bracelet's buttons without looking at them, a feature very that is very handy in an emergency situation where the user wishes to send out a distress message and cannot manipulate the phone directly. This means that when the bracelet is worn in the palm position, the user may use both his hands freely and does not need to look at the bracelet to operate it.

The communicating bracelet can be wirelessly connected to an electronic device. After connection, the communicating bracelet can send instructions to the coupled electronic device. The coupled electronic device is typically a mobile phone, but the bracelet can be used for other purposes such as entertainment or business and can communicate with other devices that can operated wirelessly such as a television set, a game console, a cable box, a set-top box, an air-conditioning unit, a projector, units of a car etc.

The bracelet of the invention comprises two portions: a base-portion and a retractable annex-portion. The base-portion is adapted to be worn on the wrist. The annex-portion which is connected to the base portion, can be either worn on the wrist (wrist mode) or moved into the palm of the hand (palm mode). In some embodiments, the annex-portion can always remain in the palm-position and not folded back into a wrist position.

The bracelet's communication unit comprises a power source and a wireless transmission module. The power source can be any sort of battery and can be either a replaceable battery (like in a wrist watch) or it can be a rechargeable battery. The rechargeable battery can be either removed from the bracelet to be recharged in a separate charging device or in some embodiments the battery can be recharged while inside the bracelet.

The transmission module of the bracelet can communicate with the coupled device via the Bluetooth protocol, Infra-Red (IR), Near Field Communications (NFC) or any other present or future wireless communications protocol.

The communication unit is connected to the one or more actionable buttons on the annex-portion of the bracelet.

In some embodiments, the communicating bracelet has several operational modes such as ON, OFF and dormant in order to save on battery power as some communication protocols such as Bluetooth can consume significant amount of energy for devices with limited battery power. In the ON position the bracelet is in communication with the couple device and ready to send instructions. In the OFF position the bracelet is completely turned off, and no action can be performed until the bracelet is first turned on. In a dormant position, the bracelet is not connected to the coupled device, but can the bracelet is ready to act upon user input, for example, only connecting to the coupled device after a first user action.

The second portion of the communicating bracelet is an annex-portion connected to the base-portion. The annex-portion is adapted to be worn either in a wrist position worn entirely on the wrist or in a palm position worn one part on the wrist and the other part on the palm between the thumb and the index finger. The annex-portion has one or more actionable buttons. When an actionable button is manipulated by the user (touching, pressing, double pressing, long press, moving, sliding etc.) a predetermined command (instruction) associated with the manipulation is transmitted to the coupled device. Example of such commands comprise, increase volume, decrease volume, next song, previous song, answer a call, reject a call, send out one or more emergency messages etc.

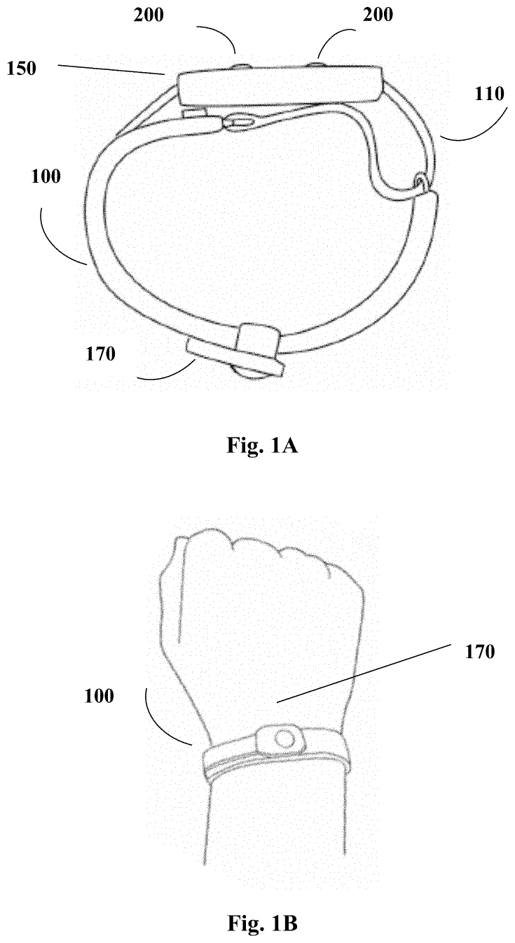

Reference is now made to FIG. 1A showing the communicating bracelet in the wrist position. The base-portion 100 and the annex-portion 110 are connected and in the wrist position the annex-portion 110 is placed (fully or partially) on top (or below) the base-portion 100 so the communicating bracelet looks like a regular bracelet (roughly a generally tubular bracelet shape). In this embodiment, the entire communication unit 150 is attached to the annex-portion 110. The communication unit 150 comprises a power source and a wireless transmission module. It is also possible for the communication unit 150 to be entirely attached to the base-portion 100 or be placed on both the base-portion 100 and the annex-portion 110.

In some embodiments, as shown in FIG. 1A, the communication unit 150 is directly connected to one or more actionable buttons 200. The one or more actionable buttons 200 are always placed on the annex-portion 110 but it is possible for the communication unit 150 to be placed on other locations on the bracelet and be connected to the one or more actionable buttons 200 via wires.

The base-portion 100 can have an adjustment mechanism 170 for adjusting the size of the base-portion 100 for different wrist sizes.

FIG. 1B shows the wrist position of FIG. 1A worn on a wrist.

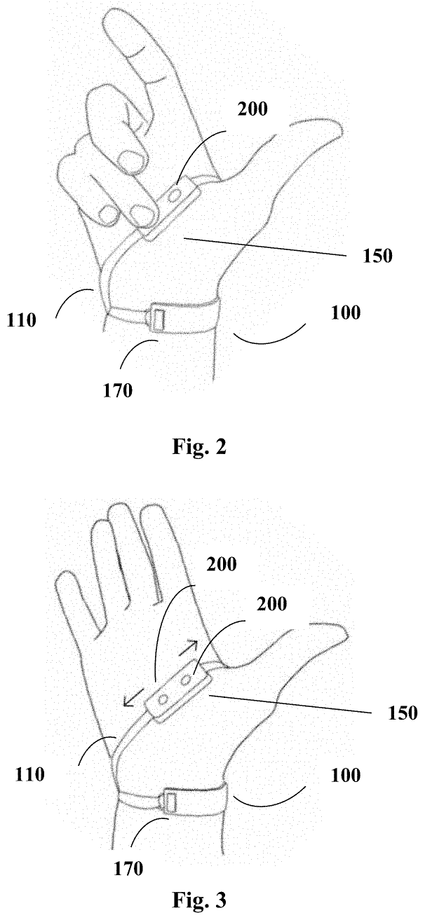

Reference is now made to FIG. 2 showing the communicating bracelet with the annex-portion 110 in the palm position. In the palm position, the annex-portion 110 is placed across the palm, going through between the thumb and the index finger. The one or more actionable buttons 200 are adapted to be preferably positioned above the thenar eminence area. The “thenar eminence” refers to the group of muscles on the palm of the human hand at the base of the thumb. FIG. 2 shows the user pressing an actionable button 200 with his ring finger. The user can actually press an actionable button without looking at it. The term “press” refers to any manipulation of an actionable button 200 such as a press, a long press, double click, sliding, moving etc.

FIG. 2 shows a communicating bracelet with actionable buttons 200 two (one visible, one not visible and being pressed), though other embodiments may have only one actionable button 200, three actionable buttons 200 or more.

Reference is now made to FIG. 3 showing an embodiment where the position of the actionable buttons 200 can be adjusted up and down the annex-portion 110 (shown the two arrows). In the embodiment shown in FIG. 3, the actionable buttons 200 are connected to the communication unit 150 which includes an adjustment mechanism such as a slider so that it can be moved across the annex-portion 110 so that each user can adjust it to the position most comfortable for him.

Typically, the annex-portion 110 comprises 1, 2 or 3 actionable buttons 200.

The actionable buttons 200 can be manipulated by touching the button 200, touching the button 200 twice within one second (or any predetermined time for a “double click” action), pressing the button 200, pressing the button 200 twice within one second, pressing the button 200 for predefined periods of time, moving the button 200, twisting the button 200, sliding the button 200 or any combination thereof. In some embodiments, one or more actionable buttons 200 is programmed to recognize different manipulations by the user, each manipulation programmed to correspond to an action the user wishes to perform on the coupled device.

The invention encompasses different types of actionable buttons 200. Some buttons 200 can be operated like a computer mouse button, recognizing actions such as but not limited to a click, a double click or a long press. Some buttons 200 can be operated like a touch surface, again recognizing actions such as but not limited to a click, a double click or a long press. Some buttons 200 can be operated like a joy stick recognizing actions such as but not limited to twisting to different directions and optionally pressing it. Some buttons 200 can be operated like a slider recognizing actions such as but not limited to moving the button to one or the other side and optionally pressing it. Some buttons 200 can also recognize pressure, for example, pressing the button for over a predetermined time can be a different action than pressing and releasing the button immediately. It is not necessary for all the actionable buttons 200 on the annex-portion 110 to be of the same type. The same annex-portion 110 may have different actionable buttons 200, for example, on central “joystick-like” button 200 and two other “touch-surface like” buttons 200 on each side. It is also possible to have actions associated with manipulating more than one button 200 simultaneously, for example, pressing two buttons 200 simultaneously.

It is important to note that an action button 200 is typically manipulated by a finger of the same hand where the annex-portion 110 is worn as shown in FIG. 2. This enables the user to manipulate the action buttons 200 with one hand, without need to look at the annex-portion 110. When not manipulating the action buttons 200 the user has both his hands free to carry any normal task. When manipulating an action button 200 the user does not need to turn his eyes to the annex-portion 110 as he can find the location of an action button 200 instinctively just by bending the finger inside the palm (in a movement similar to pressing a guitar string). This can be very useful in many situations. For example, if an action button 200 is programmed to move to the next song in a playlist, then when jogging, it is not safe for a runner to look at the annex-portion 110 while running, and the runner does not want to stop running in order to stand still, look at the annex-portion 110 and manipulate an action button 200.

In some embodiments, the communicating bracelet is activated (“ON” mode) when the annex-portion 110 is moved to palm position. This effect can be achieved, for example, by two magnets one on the annex-portion 110 and the other on the base-portion 100. When the annex-portion 110 is moved from the wrist-position to the palm-position, the two magnets are separated, an action easily detectable, for example, if the two magnets were part of an electric circuit which is broken when the magnets are no longer in contact. In some embodiments, the communicating bracelet is activated by a dedicated switch, button or similar unit on the base-portion 100 or annex-portion 110 or communication unit 150.

The action buttons 200 are programmed to recognize different manipulations, wherein each manipulation is associated with an action the user wishes to perform on the coupled device. An action button 200 can be associated with a single manipulation (i.e. only pressing it is recognized) or the action button 200 can be associated with a plurality of manipulations (i.e. “click”, “double-click”, long press etc.), each distinct manipulation is then associated with a different action the user wishes to perform on the coupled device.

The action buttons 200 can come with default actions associated with each distinct manipulation. In some embodiments, an application of the invention on a coupled mobile device (such as a mobile phone) can reprogram each distinct, recognizable manipulation to perform a different action as chosen by the user. In some embodiments, an Application Program Interface (API) enables 3^{rd} party application developers to include code in 3^{rd} party applications to reprogram one or more distinct manipulation of an action button 200 to an action offered by that 3^{rd} party application.

The annex-portion 100 is preferably made of elastic materials, including but not limited to silicon, rubber, plastics, textile or any combination thereof.

The annex-portion 100 size is adjustable to fit different sizes of palms. Size adjustment can be achieved in any way of the art, for example, like a wrist watch strap. The communicating bracelet can be worn either on the left hand or on the right hand.

In some embodiments, the position of one or more actionable buttons 200 on the annex-portion 100 is configurable, that is the buttons 200 can be moved to different locations along the annex-portion 100 in order to better fit user preferences and physiology. For example, the buttons 200 can fixated onto a rail on the bracelet, and can be released from the rail (for example, by turning the button), slide along the rail to one side or another and then being fixated at the desired location.

In some embodiments, manipulating an action button 200 results in a feedback returned to the user, as to acknowledging that the manipulation was well received by the system. The feedback may be provided by the communicating bracelet itself, for example, by vibrating, turning on a light (such as a LED), making a sound etc. Alternatively, it is also possible to provide the feedback via the coupled mobile device, for example, producing a confirmation sound on the coupled mobile phone.

The communicating bracelet can perform an action directly on the coupled device. For example on a mobile phone, actions can include moving songs in a playlist (i.e. Forward or Backward), playing/pausing a song, taking a photo, starting to shoot a video, pausing/ending the video shoot, increasing/lowering volume, making a phone call to a given number (for example police or physician), answering a call, terminating a call, rejecting an incoming call etc.

In addition, sometimes a mobile phone can operate auxiliary devices including but not limited to a television set, a game console, a projector, an air-conditioning unit, an amplifier, a set-top box, a cable box, a DVD player, an IR input unit, a smart home unit, or any device equipped with wireless communications such as all Internet of Things (IoT) devices. The communicating bracelet of the invention can thus be used to send an instruction to the mobile phone, where the instructions perform an action by the mobile phone on the auxiliary device.

In some embodiments, the communicating bracelet communicates directly with any device equipped with wireless technology, for example, a television set, a game console, a projector, an air-conditioning unit, an amplifier, a set-top box, a cable box, a DVD player, an IR input unit, a smart home unit, or any device equipped with wireless communications such as all Internet of Things (IoT) devices.

In some embodiments, the annex-portion 110 is always in the palm position and never folds back into the base-portion 100 thus the communicating bracelet only has a palm position.

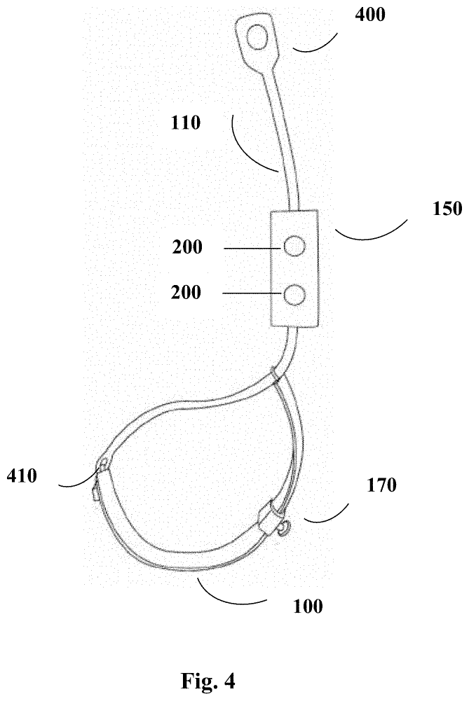

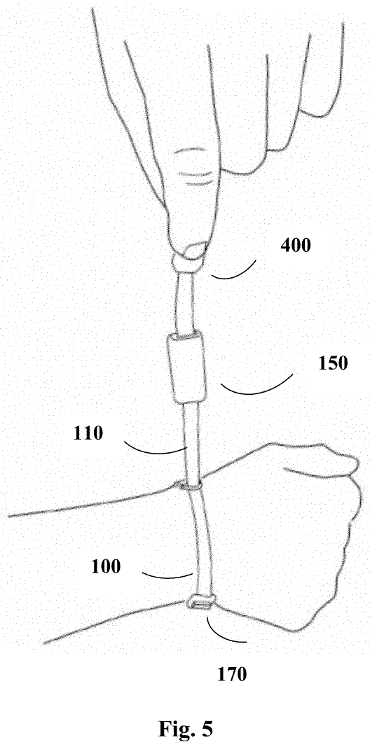

FIGS. 4-5 show an embodiment of a communicating bracelet where the annex-portion 110 is can be disconnected from the base-portion 100 at one end when moving from the wrist position to the palm position. The annex-portion 110 comprises a locking mechanism 400 at the disconnected end that is adapted to connect to the base-portion 100 on connector 410 after being passed across the wrist to the palm position. The locking mechanism 400 and its connector 410 can be any locking mechanism known in the art such as two magnets, a locking mechanism 400 with a hole (as shown in FIG. 4) being placed on a connector 410 with a bulge where the hole has to squeeze the bulge a bit to fit and thus remains connected. FIG. 5 shows the annex-portion 110 open before being passed across the wrist to the palm position.

In some embodiments, the annex-portion 110 is never disconnected from the base-portion 100 and is stretched when moved to the palm position.

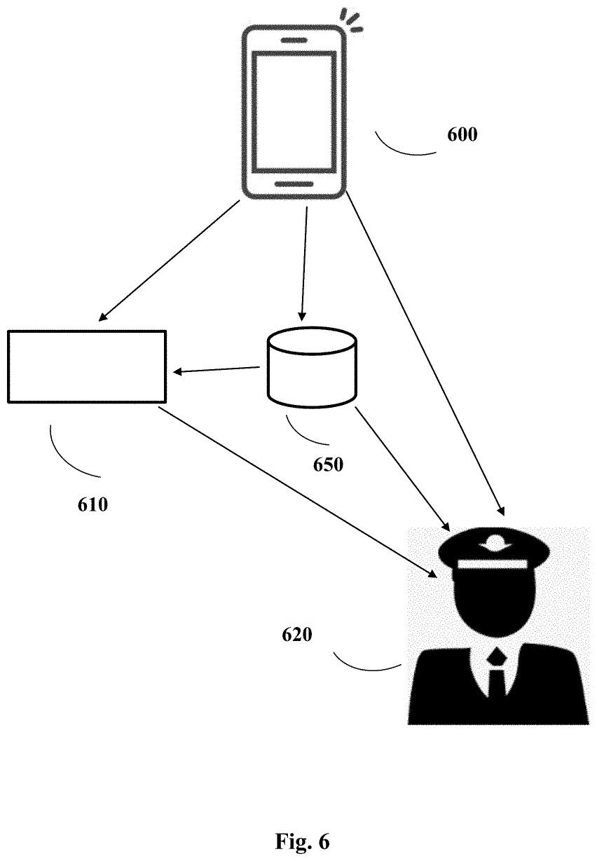

FIG. 6 is a block diagram showing the mobile phone connecting to a security service and uploading sound and/or video. There may be moments where a user feels very unsafe, feels he's in a dangerous situation, for example, finding himself/herself alone at night in a dark street with someone menacing approaching. In these types of situations, the user may not feel comfortable or safe to take out his phone and make an emergency call (to a friend, family, 911 etc.) for several reasons such as the user may not want to distract his attention from the approaching person, the user may fear his phone will be robbed, the user may not want to show that he is stressed or making an emergency call. For whatever reason it may be, when the user can still send out an emergency message by using the bracelet and mobile application of the invention.

The user can discretely move the annex-portion 110 to the palm position, and discretely, while not taking his eyes off the danger, press the predefined button or combination of buttons to generate a personal safety instruction.

Once the user has sent out the personal safety instruction regarding a dangerous situation he is in, by pressing the predefined button manipulating for that purpose. The personal safety instruction is transmitted by the communication unit to a mobile phone application 600. The mobile phone application 600 then proceeds to query the phone location, via any available method such as the phone's GPS unit, querying the cell ID, via location information available by the phone's operating system and/or any application etc.

The mobile phone application 600 connects to a predefined security service, sending a personal emergency message comprising at least the user's identity and available location information. The predefined security service may be either a commercial service 610 or a law enforcement agency 620. A commercial service 610 can be a commercial security service, for example, a security service that can dispatch qualified personnel to the location of the user in order to locate and rescue the user if needed. A commercial service 610 can also be a service that processes the received information from the mobile phone and then contacts a law enforcement agency 620, either by placing a phone call (by a person or by a machine using text-to-speech or similar technologies) or by sending a message.

The law enforcement agency 620 can be the police, a general emergency number, local Sheriff office or any other similar agency that could help rescue the user.

The mobile phone application 600 also attempts to open the mobile phone's microphone or camera or both, depending on availability, access permissions, and predefined preferences. The camera may capture stills, video or alternate, for example, take a picture, 15 seconds video, and then again a picture, 15 seconds video and so on. The captured media sound and/or stills and/or video is transmitted to a dedicated database 650 and made available to the predefined security service.

The location information of the mobile phone is also updated and uploaded to the database 650 continuously or frequently. Location updates may be continuously or under a second, every second, every 2 seconds, every 3, 4, 5, 6, 7, 8, 9, 10, 15 or every 20 seconds etc.

The database 650 can belong to the security service, where access permissions have been granted to the mobile phone beforehand. Alternatively, the database 650 can be a commercial service database where the user has a subscription, for example, a cloud storage such as Dropbox™ or any similar storage service accessible by the mobile phone, and where the user can upload data and authorize access to that data to the predefined security service.

In some embodiments, the captured sound and/or images and/or video are processed to identify potential danger to the user of the mobile phone. For example, sound can be analyzed to identify menacing speech, calling for help, stress and panic in the voice of the user etc. Images (stills or video) can be analyzing to identify personal aggression, weapons, violence etc.

The sound and image analysis can be performed by the security service or by a dedicated third party that is granted access to the database 650.

In some situations, the user may enter a potentially unsafe location, but there are no immediate sign of a dangerous event. For example, entering a dark parking at night to fetch his car, not seeing anybody suspicious but feeling unsafe. The user may then press a predefined action to place the system on a watch mode. In a watch mode, the system may start recording sound, stills and/or video, and will wait for a user action every predefined amount of time, to reconfirm the user is safe. For example, in watch mode, the user may need to press a given button every 30 seconds to signal he's OK. If the user doesn't press the right button (or buttons) in 30 seconds or if the user hasn't pressed the action to cancel watch mode, the system treats the situation as an emergency situation, and sends a personal emergency message to the security service. In case the user is surprised and unable to take further action, the system will launch a personal emergency message when the user fails to reconfirm his safety.

Naturally, the required time between each confirmation can be configured by the system and/or user.

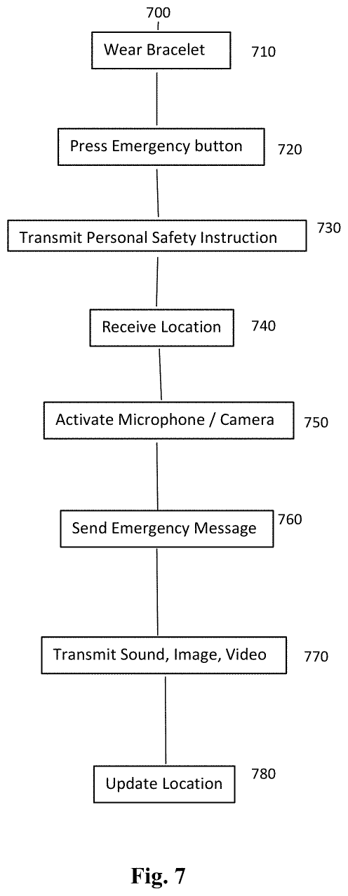

Reference is made to FIG. 7, showing an exemplary process of sending out an emergency message according to one embodiment of the present invention.

In step 700 the process starts.

In step 710 the user wears a personal bracelet comprising a base-portion adapted to be worn on the wrist and an annex-portion connected to the base-portion and adapted to be retracted and worn in a palm position across the palm between the thumb and the index finger, the annex-portion comprising one or more actionable buttons;

In step 720 the user manipulates one or more of the actionable buttons, defined as the button or buttons to be pressed in case of emergency and wanting to call for help;

In step 730 the communication unit on the bracelet transmits a personal safety instruction to a mobile phone application, running on a connected mobile phone;

In step 740 the mobile application receives location information;

In step 750 the mobile application activates the mobile phone's microphone or camera or both to capture sound and/or still images and/or video;

In step 760 the mobile application sends a personal emergency message to a predefined security service, the message comprising at least the user's identity and location information;

In step 770 the mobile application repeatedly transmits to a database coupled to said security service the captured sound and/or still images and/or video; and

In step 780 the mobile application repeatedly updates in said database mobile phone location.

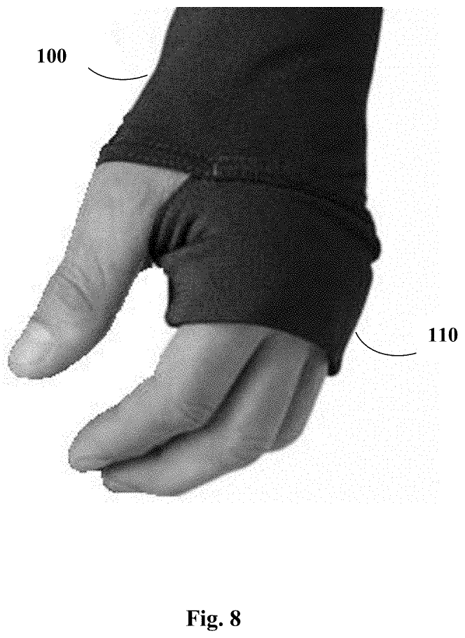

FIG. 8 shows an embodiment the communicating bracelet where the base-portion is a shirt with a hole at the end of the sleeve. The user has the option to insert the thumb in the hole and adopting a palm position. In this embodiment, the shirt comprises wireless communications technology and pressing action buttons 200 on the palm side (not shown) sends predefined instructions to a coupled device.

Use Cases

The following cases illustrate some examples of instructions associated with action buttons activating functions on a mobile phone. Each action is associated with a particular manipulation of one (or more) action buttons 200:
1. Personal safety—activating a distress message in an emergency or dangerous situation. A predefined action (preferably one that cannot be pressed by accident), such as a long-press on one button, long-press on two buttons etc., can trigger sending out a personal safety message to a connected mobile phone application including at least the user's identity and location information. The mobile phone application may also receive continuous location information and sound and/or video that might be captured by the mobile phone's microphone and/or camera. The mobile application can then send out a message to a law agency such as the police, or indirectly, via a call center that we then call the police, reporting the user's identity, location and any other available information about the emergency event.
2. Friend Alert—activating a mobile application alerting/reporting process. The alerting process can send messages (SMS and/or Instant Messages for example) to one or more preconfigured contacts. The alerting process may also initiate one or phone calls to a predetermined contacts or law authorities. The alerting process can communicate the user's location, take pictures, videos, and record sound all to be communicated to the people receiving the messages and/or calls. Pictures, video and sound may be communicated via a link to a predefined storage location (for example on the cloud). The alert function may be used by:
   older population
   kids and youth
   population with medical conditions (diabetes, epileptic, heart attack, stroke etc.)
   military/security
   joggers, hikers etc.
3. Call management—answering a call, reject an incoming call, mute, volume adjustment, auto text messaging etc.
4. Music and movies—play/pause, forward/backward, practical while doing additional activity i.e. sports, driving, teaching.
5. Presentations—managing slides, video, links during presentation while speaking and keep hands free and eye contact.
6. Camera—remote picture on chosen time of own (“selfie”) or distant location, play, record, pause, or stop video.
7. “Smart house”—activation of various advanced home technologies. The bracelet will enable identification of the user within the house and will adjust to his set preferences per location.
8. Military and Security needs—remote activation of security devices (i.e. PTT, cameras, lights), reporting location, call for backup.
9. Handicap population—management of different applications with minimal physical activity.
10. Incoming call message alert from a predetermined contact—when receiving a call or message from a predetermined contact the communicating bracelet can vibrate (in a predetermined vibration pattern). This is practical, for example, when entering a meeting with the phone in quiet mode, but needing to monitor receiving an important call or message from a predetermined contact.

Although the invention has been described in detail, nevertheless changes and modifications, which do not depart from the teachings of the present invention, will be evident to those skilled in the art. Such changes and modifications are deemed to come within the purview of the present invention and the appended claims.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium®. or Centrino.™. processor, that are adapted to communicate with the computer. Any number and type of machines may be in communication with the computer.

1. A personal safety system for alerting in an emergency situation, the system comprising:
A. a personal bracelet, comprising
(i) a base-portion adapted to be worn on the wrist;
(ii)an annex-portion connected to the base-portion and adapted to be retracted and worn in a palm position across the palm between the thumb and the index finger, the annex-portion comprising one or more actionable buttons;
(iii) a communication unit connected to said one or more actionable buttons comprising a power source and a wireless transmission module,
wherein when, in an emergency situation, one or more buttons of said actionable buttons are manipulated by the user, a personal safety instruction associated with said manipulation is transmitted by the wireless transmission unit to the coupled mobile phone; and
B. a mobile phone application running on said couple mobile phone, adapted to receive instructions from said wireless transmission unit, and perform the following actions in response:
(v)send a personal emergency message to a predefined security service, the message comprising at least the identity of the mobile phone user and mobile phone location information;
(vi) activate at least one of the mobile phone's microphone and camera to capture sound and/or video;
(vii) continuously transmit to a database coupled to said security service the captured sound and/or video; and
(viii) transmit to said database continuously or at predetermined intervals, mobile phone location information.

2. The personal safety system according to claim 1, wherein said security service is a law enforcement agency or a commercial service.

3. The personal safety system according to claim 2, wherein said security service is a commercial security agency and said commercial security service contacts a law enforcement agency to assist the mobile phone user.

4. The personal safety system according to claim 3, wherein said commercial security service transmits to said law enforcement agency or makes available to said law enforcement agency, any sound and/or video received from the mobile phone.

5. The personal safety system according to claim 1, wherein said database is associated with the user of the mobile phone and access to said database is given to said security service.

6. The personal safety system according to claim 1, wherein the sound and/or video are processed to identify potential danger to the mobile phone user.

7. The personal safety system according to claim 1, said emergency message places the system in a watch mode, and the system awaits for a predetermined amount of time for an instruction to maintain or cancel the watch mode before acting on the emergency situation.

8. The personal safety system according to claim 1, wherein an actionable button can be manipulated by touching the button, touching the button twice within a predetermined time, pressing the button, pressing the button twice within a predetermined time, pressing the button for predefined periods of time, moving the button, twisting the button, sliding the button or any combination thereof.

9. The personal safety system according to claim 1, wherein more than one actionable buttons are manipulated simultaneously.

10. The personal safety system according to claim 1, wherein the position of one or more actionable buttons on the annex-portion is configurable, such that said one or more actionable buttons can be moved to a different location along the annex-portion in order to better fit user preferences and physiology.

11. The personal safety system according to claim 1, wherein the communicating bracelet is a shirt with an opening at the end of a sleeve.

12. A personal safety method for alerting in an emergency situation, comprising the steps:
wearing a personal bracelet comprising a base-portion adapted to be worn on the wrist and an annex-portion connected to the base-portion and adapted to be retracted and worn in a palm position across the palm between the thumb and the index finger, the annex-portion comprising one or more actionable buttons;
manipulating one or more of the actionable buttons;
transmitting a personal safety instruction to a mobile phone application;
receiving location information;
activating the mobile phone's microphone or camera or both to capture sound and/or still images and/or video;
sending a personal emergency message to a predefined security service, the message comprising at least the user's identity and location information;
repeatedly transmitting to a database coupled to said security service the captured sound and/or still images and/or video; and
repeatedly updating in said database mobile phone location information.

13. The personal safety method according to claim 12, wherein said security service is a law enforcement agency or a commercial service.

14. The personal safety method according to claim 13, wherein said security service is a commercial security agency and said commercial security service contacts a law enforcement agency to assist the mobile phone user.

15. The personal safety method according to claim 14, wherein said commercial security service transmits to said law enforcement agency or makes available to said law enforcement agency, any sound and/or video received from the mobile phone.

16. The personal safety method according to claim 12, wherein said database belongs to the user of the mobile phone or to a third party, and access to said database is given to said security service.

17. The personal safety method according to claim 12, wherein the sound and/or video are processed to identify potential danger to the mobile phone user.

18. The personal safety method according to claim 12, said emergency message places the system in a watch mode, and the system awaits for a predetermined amount of time for an instruction to maintain or cancel the watch mode before acting on the emergency situation.
